(19) United States
(12) Patent Application Publication
(10) Pub. No.: US 2003/0065904 A1
(43) Pub. Date: Apr. 3, 2003

(54) Programmable array for efficient computation of convolutions in digital signal processing

(75) Inventors: Geoffrey Burns, Ridgefield, CT (US); Krishnamurthy Vaidyanathan, Ossinging, NY (US)

Correspondence Address: Corporation Patent Counsel, U.S. Philips Corporation, 580 White Plains Road, Terrytown, NY, 10591, US

(73) Assignee: KONINKLIJKE PHILIPS ELECTRONICS N.V.

(21) Appl. No.: 09/968,119

(22) Filed: Oct. 1, 2001

(51) Int. Cl. G06F 15/00

(52) U.S. Cl. 712/11

(57) ABSTRACT

A component architecture for digital signal processing is presented. A two dimensional reconfigureable array of identical processors, where each processor communicates with its nearest neighbors, provides a simple and power-efficient platform to which convolutions, finite impulse response (“FIR”) filters, and adaptive finite impulse response filters can be mapped. An adaptive FIR can be realized by downloading a simple program to each cell. Each program specifies periodic arithmetic processing for local tap updates, coefficient updates, and communication with nearest neighbors. During steady state processing, no high bandwidth communication with memory is required.

This component architecture may be interconnected with an external controller, or general purpose digital signal processor, either to provide static configuration or else supplement the steady state processing.

### TECHNICAL FIELD

This invention relates to digital signal processing, and more particularly, to optimizing digital signal processing operations in integrated circuits.

### BACKGROUND OF THE INVENTION

Convolutions are common in digital signal processing, being commonly applied to realize finite impulse response (FIR) filters. Below is the general expression for convolution of the data signal X with the coefficient vector C:

$${y}_{n} = {\sum }_{i = 0}^{N} {c}_{i} \times {x}_{n - i}$$

where it is assumed that the data signal X and the system response, or filter co-efficient vector C, are both causal.

For each output datum, yₙ, 2N data fetches from memory, N multiplications, and N product sums must be performed. Memory transactions are usually performed from two separate memory locations, one each for the coefficients Cᵢ and data xₙ₋ᵢ. In the case of real-time adaptive filters, where the coefficients are updated frequently during steady state operation, additional memory transactions and arithmetic computations must be performed to update and store the coefficients. General-purpose digital signal processors have been particularly optimized to perform this computation efficiently on a Von Neuman type processor. In certain applications, however, where high signal processing rates and severe power consumption constraints are encountered, the general-purpose digital signal processor remains impractical.

To deal with such constraints, numerous algorithmic and architectural methods have been applied. One common method is to implement the processing in the frequency domain. Thus, algorithmically, the convolution can be transformed to a product of spectrums using a given transform, e.g. the Fourier Transform, then an inverse transform can produce the desired sum. In many cases, efficient fast Fourier transform techniques will actually reduce the overall computation load below that of the original convolution in the time domain. In the context of single carrier terrestrial channel decoding, just such a technique has been proposed for partial implementation of the ATSC 8-VSB equalizer, as described more fully in U.S. patent applications Ser. Nos. 09/840,203, and 09/840,200, Dagnachew Birru, Applicant, each of which is under common assignment herewith. The full text of each of these applications are hereby incorporated herein by this reference.

In cases where the convolution is not easily transformed to the frequency domain due to algorithm requirements or memory constraints, specialized ASIC processors have been proposed to implement the convolution, and support specific choices in adaptive coefficient update algorithms, as described in Grayver, A. Reconfigurable 8 GOP ASIC Architecture for High-Speed Data Communications, IEEE Journal on Selected Areas in Communications, Vol. 18, No. 11 (November, 2000); and E. Dujardin and O. Gay-Bellile, A Programmable Architecture for digital communications: the mono-carrier study, ISPACS 2000, Honolulu, November 2000

Important characteristics of such ASIC schemes include: (1) a specialized cell containing computation hardware and memory, to localize all tap computation with coefficient and state storage; and (2) the fact that the functionality of the cells is programmed locally, and replicated across the various cells.

Research in advanced reconfigurable multiprocessor systems has been successfully applied to complex workstation processing systems. Michael Taylor, writing in the Raw Prototype Design Document, MIT Laboratory for Computer Science, January 2001, for example, describes an array of programmable processor “tiles” that communicate using a static programmable network, as well as a dynamic programmable communication network. The static network connects arbitrary processors using a re-configurable crossbar network, with interconnection defined during configuration, while the dynamic network implements a packet delivery scheme using dynamic routing. In each case interconnectivity is programmed from the source cell.

In all of the architectural solutions described above, however, either flexibility is compromised by restricting filters to a linear chain (as in the Grayver reference), or else the complexity is high because the scope of processing to be addressed goes beyond convolutions (as in the Dujardin & Gay-Bellile, and Taylor references; in the Taylor reference, for example, an array of complex processors is described, such that a workstation can be built upon the system therein described). Therefore, no current system, whether proposed or extant, provides both flexibility with the efficiency of simplicity.

An advantageous improvement over these schemes would thus be to enhance flexibility for the convolution problem, yet maintain simple program and communication control.

### SUMMARY OF THE INVENTION

A component architecture for the implementation of convolution functions and other digital signal processing operations is presented. A two dimensional array of identical processors, where each processor communicates with its nearest neighbors, provides a simple and power-efficient platform to which convolutions, finite impulse response (“FIR”) filters, and adaptive finite impulse response filters can be mapped. An adaptive FIR can be realized by downloading a simple program to each cell. Each program specifies periodic arithmetic processing for local tap updates, coefficient updates, and communication with nearest neighbors. During steady state processing, no high bandwidth communication with memory is required.

This component architecture may be interconnected with an external controller, or a general purpose digital signal processor, either to provide static configuration or else to supplement the steady state processing.

In a preferred embodiment, an additional array structure can be superimposed on the original array, with members of the additional array structure consisting of array elements located at partial sum convergence points, to maximize resource utilization efficiency.

### BRIEF DESCRIPTION OF THE DRAWINGS

FIG. 1 depicts an array of identical processors according the present invention;

FIG. 2 depicts the fact that each processor in the array can communicate with its nearest neighbors;

FIG. 3 depicts a programmable static scheme for loading arbitrary combinations of nearest neighbor output ports to logical neighbor input ports according to the present invention;

FIG. 4 depicts the arithmetic control architecture of a cell according to the present invention;

FIGS. 5 through 11 illustrate the mapping of a 32-tap real FIR to a 4×8 array of processors according to the present invention;

FIGS. 12 through FIG. 14 illustrate the acceleration of the sum combination to a final result according to a preferred embodiment of the present invention;

FIG. 15 illustrates a 9×9 tap array with a superimposed 3×3 array according to the preferred embodiment of the present invention;

FIG. 16 depicts the implementation of an array with external micro controller and random access configuration bus;

FIG. 17 illustrates a scalable method to officially exchange data streams between the array and external processes;

FIG. 18 depicts a block diagram for the tap array element illustrated in FIG. 17; and

FIG. 19 depicts an exemplary application according to the present invention.

### DETAILED DESCRIPTION OF THE PREFERRED EMBODIMENTS

An array architecture is proposed that improves upon the above described prior art, by providing the following features: a novel intercell communication scheme, which allows progression of states between cells, as new data is added, a novel serial addition scheme, which realizes the product summation, and cell programming, state and coefficient access by an external device.

The basic idea of the invention is a simple one. A more efficient and more flexible platform for implementing DSP operations is presented, being a processor array with nearest neighbor communication, and local program control. The benefits of same over the prior art, as well as the specifics of which, will next be described with reference to the indicated drawings.

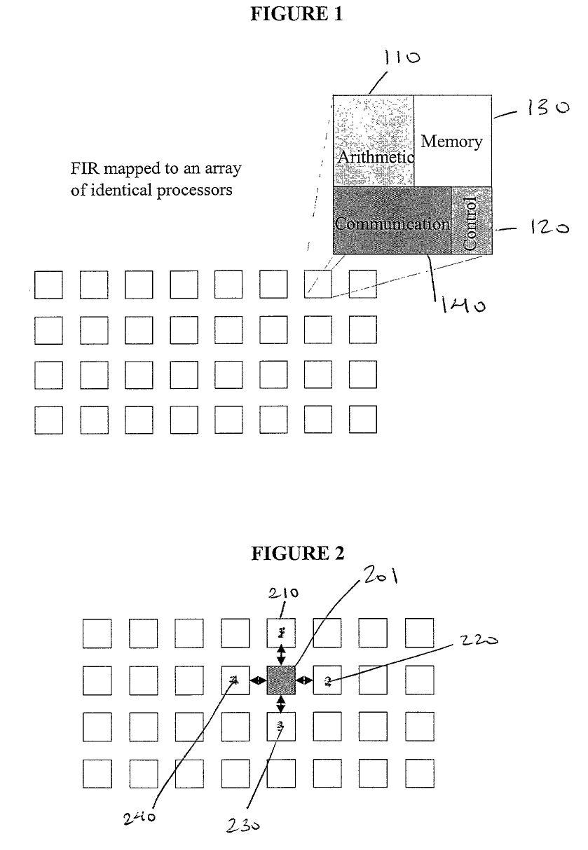

As illustrated in FIG. 1, a two-dimensional array of identical processors is depicted (in the depicted exemplary embodiment a 4×8 mesh), each of which contains arithmetic processing hardware 110, control 120, register files 130, and communications control functionalities 140. Each processor can be individually programmed to either perform arithmetic operations on either locally stored data; or on incoming data from other processors.

Ideally, the processors are statically configured during startup, and operate on a periodic schedule during steady state operation. The benefit of this architecture choice is to co-locate state and coefficient storage with arithmetic processing, in order to eliminate high bandwidth communication with memory devices.

The following are the beneficial objectives achieved by the present invention:

1. Retention of consistent cell and array structure, in order to promote easy optimization;

2. Provision for scalability to larger array sizes;

3. Retention, to the extent possible, of localized communication to minimize power and avoid communication bottlenecks;

4. Straightforward programming; and

5. The allowance for eased development of mapping methods and tools, if required.

FIG. 2 depicts the processor intercommunication architecture. In order to retain programming and routing simplicity, as well as to minimize communication distances, communication is restricted to being between nearest neighbors. Thus, a given processor 201 can only communicate with its nearest neighbors 210, 220, 230 and 240.

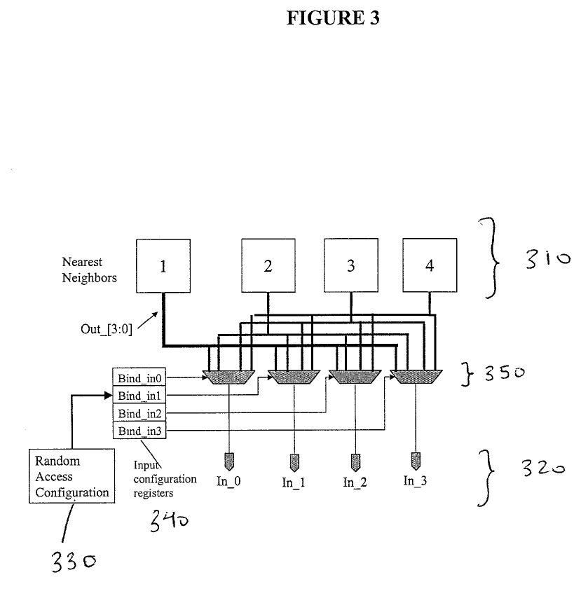

As shown in FIG. 3, communication with nearest neighbors is defined for each processor by referencing a bound input port as a communication object. A bound input port is simply the mapping of a particular nearest neighbor physical output port 310 to a logical input port 320 of a given processor. The logical input port 320 then becomes an object for local arithmetic processing in the processor in question. In a preferred embodiment, each processor output port is unconditionally wired to the configurable input port of its nearest neighbors. The arithmetic process of a processor can write to these physical output ports, and the nearest neighbors of said processor, or array element, can be programmed to accept the data if desired.

According to the random access configuration 330 depicted in FIG. 3, a static configuration step can load mappings of arbitrary combinations of nearest neighbor output ports 310 to logical input ports 320. The mappings are stored in the Bind_inx registers 340 that are wired as selection signals to configuration multiplexers 350, that realize the actual connections of incoming nearest neighbor data to the internal logical input ports of an array element, or processor.

Although the exemplary implementation of FIG. 3 depicts four output ports per cell, in an alternate embodiment, a simplified architecture of one output port per cell can be implemented to reduce or eliminate the complexity of a configurable input port. This measure would essentially place responsibility on the internal arithmetic program to select the nearest neighbor whose output is desired as an input, which in this case would be wired to a physical input port.

In other words, the feature depicted in FIG. 3 allows a fixed mapping of a particular cell to one input port, as would be performed in a configuration mode. In the simplified method, this input binding hardware, and the corresponding configuration step, are eliminated, and the run-time control selects which cell output to access. The wiring is identical in the simplified embodiment, but cell design and programming complexity are simplified.

The more complex binding mechanism depicted in FIG. 3 is a most useful feature when sharing controllers between cells, thus making a Single Instruction Multiple Data, or “SIMD” machine.

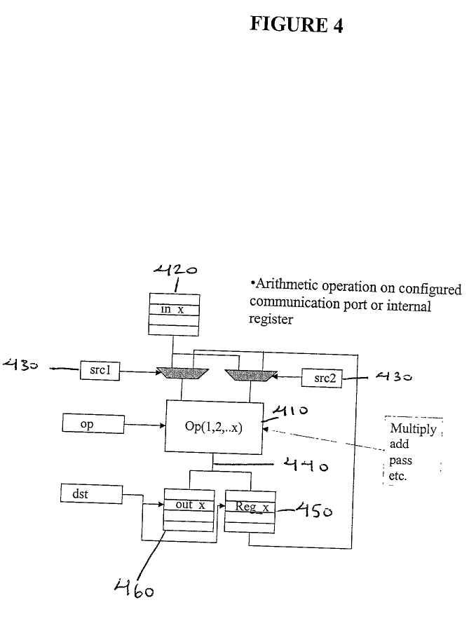

FIG. 4 illustrates the architecture for arithmetic control. A programmable datapath element 410 operates on any combination of internal storage registers 420 or input data ports 430. The datapath result 440 can be written to either a selected local register 450 or else to one of the output ports 460. The datapath element 410 is controlled by a RISC-like opcode that encodes the operation, source operands (srcx) and destination operand (dstx), in a consistent opcode. For adaptive FIR filter mapping a simple cyclic program can be downloaded to each cell. The controller consists of a simple program counter addressing a program storage device, with the resulting opcode applied to the datapath. Coefficients and states are stored in the local register file. In the depicted embodiment the tap calculation entails a multiplication of the two, followed by a series of additions of nearest neighbor products in order to realize the filter summation. Furthermore, progression of states along the filter delay line is realized by register shifts across nearest neighbors.

More complex array cells can be defined with multiple datapath elements controlled by an associated Very Large Instruction Word, or “VLIW”, controller. An application specific instruction processor (ASIP), as generated by architecture synthesis tools such as, for example, AR|T Designer, can be used to realize these complex array processing elements.

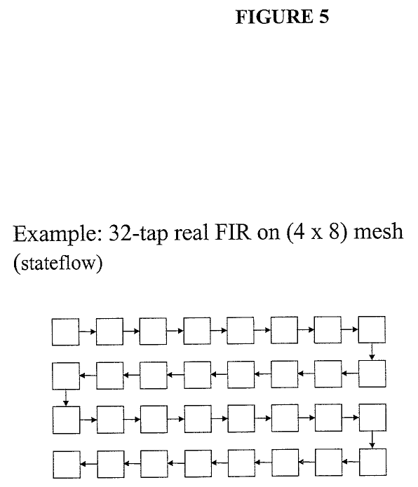

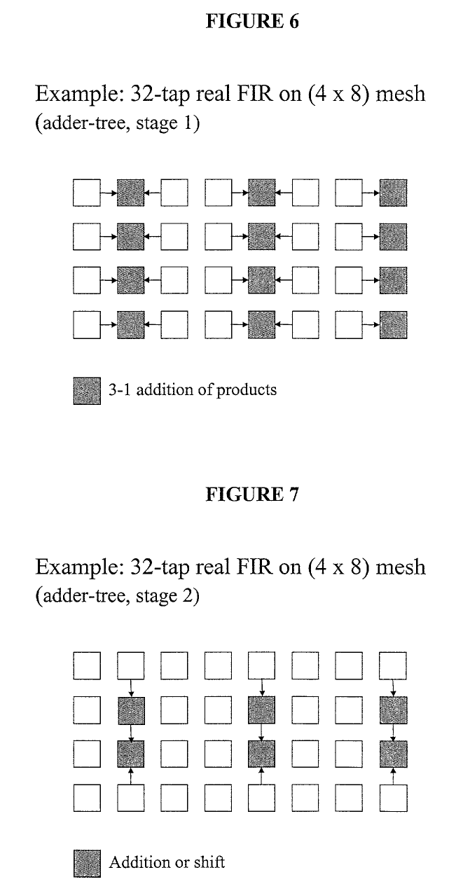

In an exemplary implementation of the present invention, FIGS. 5 through 11 illustrate the mapping of a 32-tap real FIR filter to a 4×8 array of processors, which are arranged and programmed according to the architecture of the present invention, as detailed above. State flow and subsequent tap calculations are realized as depicted in FIG. 5, where in a first step each of the 32 cells calculates one tap of the filter, and in subsequent steps (six processor cycles, depicted in FIGS. 6-11) the products are summed to one final result. For ease of discussion, an individual array element will be hereinafter designated as the (i,j) element of an array, where i gives the row, and j the column, and the top left element of the array is defined as the origin, or (1,1) element.

Thus, FIGS. 6-11 detail the summation of partial products across the array, and show the efficiency of the nearest neighbor communication scheme during the initial summation stages. In the step depicted in FIG. 6, along each row of the array, columns 1-3 are implementing 3:1 additions with the results stored in column 2, columns 4-6 are implementing 3:1 additions with the results stored in column 5, and columns 7-8 are implementing 2:1 additions with the results stored in column 8. In the step depicted in FIG. 7 the intermediate sums of rows 1-2 and rows 3-4 in each of columns 2, 5 and 8 of the array are combined, with the results now stored in elements (2,2), (2,5), and (2,8), and (3,2), (3,5), and (3,8), respectively. During these steps the processor hardware and interconnection networks are well utilized to combine the product terms, thus efficiently utilizing the available resources.

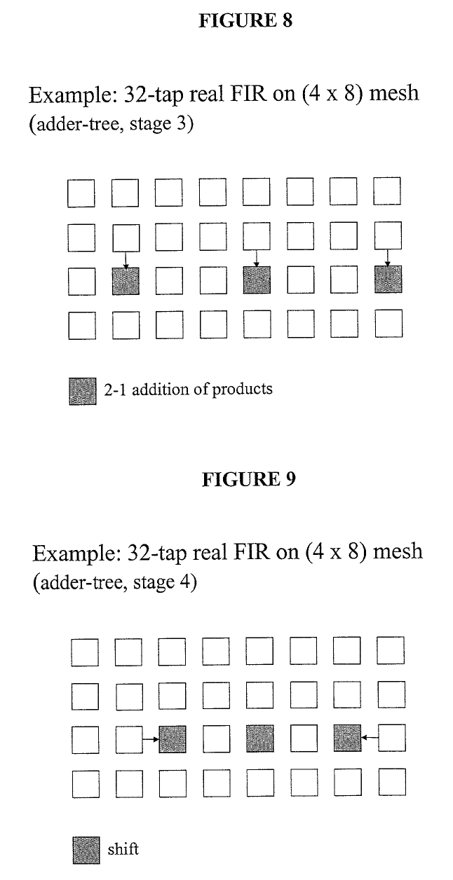

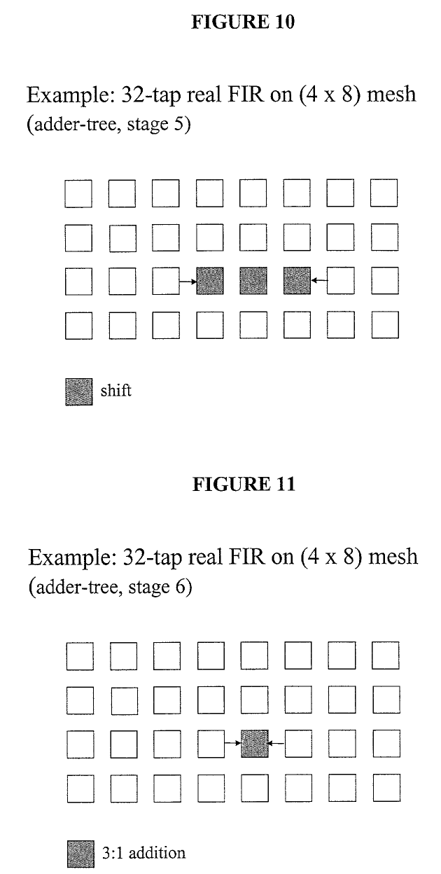

By the step depicted in FIG. 8 however, the entire array must be occupied in an addition step involving the three pairs of array elements where the results of the step depicted in FIG. 7 were stored. In the steps depicted in FIGS. 9 through 10 the entire array is involved in shifting these three partial sums to adjacent cells in order to combine them to the final result, as shown in FIG. 11, with the final 3:1 addition, storing the final result in array element (3,5).

As can be seen, to idle the rest of the array for combining remote partial sums is somewhat inefficient. Architecture enhancements to facilitate the combination with a better utilization of resources should ideally retain the simple array structure, programming model, and remain scalable. Relaxing the nearest neighbor requirements to allow communication with additional neighbors would complicate routing and processor design, and would not preclude the proximity problem in larger arrays. Thus, in a preferred embodiment, an additional array structure can be superimposed on the original, with members consisting of array elements located at partial sum convergence points after two 3:1 nearest neighbor additions (i.e., in the depicted example, after the stage depicted in FIG. 6). This provides a significant enhancement for partial sum collection.

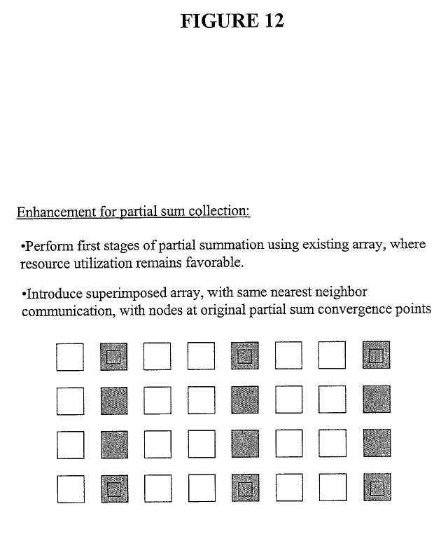

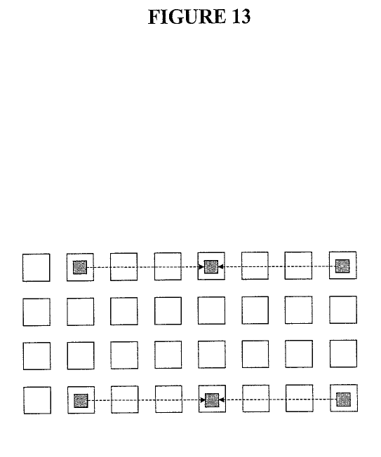

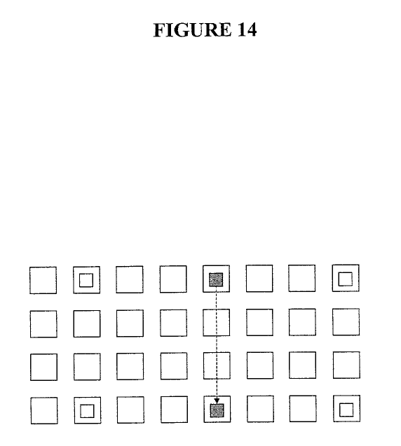

The superimposed array is illustrated in FIG. 12. The superimposed array retains the same architecture as the underlying array, except that each element has the nearest partial sum convergence point as its nearest neighbor. Intersection between the two arrays occurs at the partial sum convergence point as well. Thus in the preferred embodiment, the first stages of partial summation are performed using the existing array, where resource utilization remains favorable, and the later stages of the partial summation are implemented in the superimposed array, with the same nearest neighbor communication, but whose nodes are at the original partial sum convergence points, i.e., columns 2, 5, and 8 in FIG. 12. FIGS. 12 through 14 illustrate the acceleration of the sum combination to a final result.

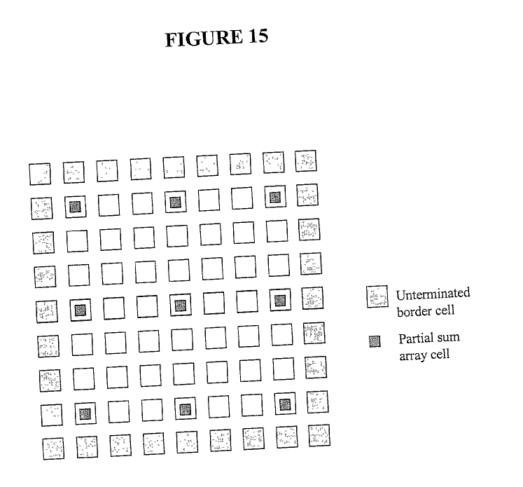

FIG. 15 illustrates a 9×9 tap array, with a superimposed 3×3 array. The superimposed array thus has a convergence point at the center of each 3×3 block of the 9×9 array. Larger arrays with efficient partial product combinations are possible by adding additional arrays of convergence points. The resulting array size efficiently supported is 9^{N-1}, where N is the number of array layers. Thus, for N layers, up to 9^{N} cell outputs can be efficiently combined using nearest neighbor communication; i.e., without having isolated partial sums which would have to be simply shifted across cells to complete the filter addition tree.

The recursion as the array size grows is easily discernable from the examples discussed above. FIGS. 12-14 show how to use another array level to accelerate tap product summation using the nearest neighbor communication. The second level is identical to the original underlying level, except at x3 periodicity, and the cells are connected to the underlying cell that produces a partial sum from a cluster of 9 level 0 cells.

The number of levels needed depends upon the number of cells desired to be placed in the array. If there is a cluster of nine taps in a square, then nearest neighbor communication can sum all the terms with just one array level with the result accumulating in the center cell.

For larger arrays, up to 81 cells, one would organize the cells in clusters of 9 cells, placing a level 1 cell above each cluster center to receiver the partial sum, and connect each cluster together at both level 0 and level 1. At level 1, the nearest neighbors are the output of the adjacent clusters (now containing the partial sums which would otherwise be isolated without the level 1 array). For this 3×3 super cluster of 9 level 0 cells, the result will appear in the center level 1 cell after the level 1 partial sums are combined.

For arrays larger than 81 and less than 729 (93³), one would assemble super clusters of 81 level 0 cells, with the 3×3 level 1 cells, and then place a level 2 cell above the center cell of the cluster to receive the level 1 partial sum. All three levels are connected together, and thus the level 2 cells can now combine partial products from adjacent super clusters using nearest neighbor communication, with the result appearing in the center level 2 cell.

The array can be further grown by applying the super clustering recursively. Of course, at some point, VLSI wire delay limitations become a factor as the upper level cells become physically far apart, thus ultimately limiting the scalability of the array.

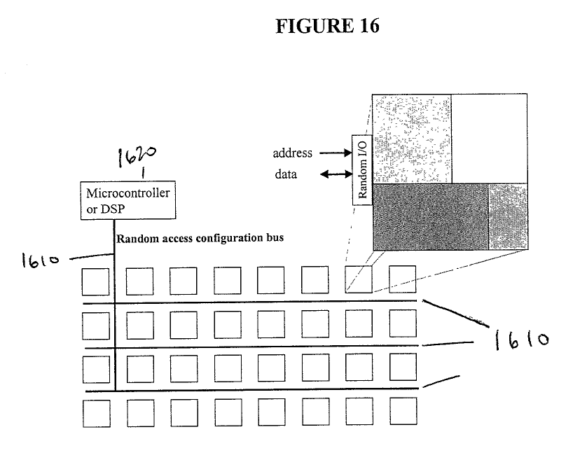

Next will be described the method for communicating configuration data to the array elements, and the method for exchanging sample streams between the array and external processes. One method that is adequate for configuration, as well as sample exchange with small arrays, is illustrated in FIG. 16. Here a bus 1610 connects all array elements to an external controller 1620. The external controller can select cells for configuration or data exchange, using an address broadcast and local cell decoding mechanism, or even a RAM-like row and column predecoding and selection method. The appeal of this technique is its simplicity; however, it scales poorly with large array sizes and can become a communication bottleneck for large sample exchange rates.

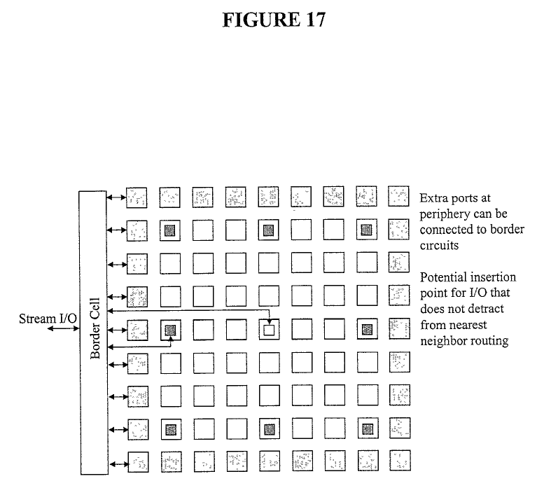

FIG. 17 illustrates a more scalable method to efficiently exchange data streams between the array and external processes. The unbound I/O ports at the array border, at each level of array hierarchy, can be conveniently routed to a border cell without complicating the array routing and control. The border cell can likely follow a simple programming model as utilized in the array cells, although here it is convenient to add arbitrary functionality and connectivity with the array. As such, the arbitrary functionality can be used to insert inter-filter operations such as the slicer of a decision feedback equalizer. Furthermore, the border cell can provide the external stream I/O with little controller intervention. In a preferred embodiment the bus in FIG. 16 for static configuration purposes, is combined along with the border processor depicted in FIG. 17 for steady state communication, thus supporting most or all applications.

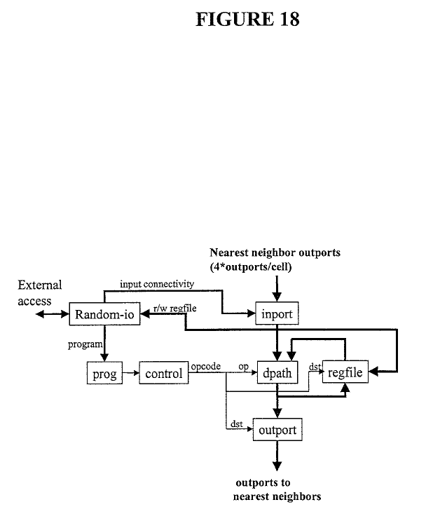

A block diagram illustrating the data flow, as described above, for the tap array element is depicted in FIG. 18.

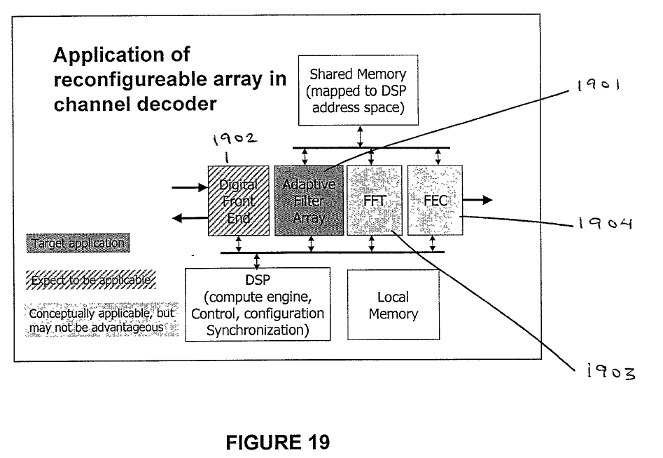

Finally, as an example of the present invention in a specific applications context, FIG. 19 depicts a multi standard channel decoder, where the reconfigureable processor array of the present invention has been targeted for adaptive filtering, functioning as the Adaptive Filter Array 1901. The digital filters in the front end, i.e., the Digital Front End 1902 can also be mapped to either the same or some other optimized version of the apparatus of the present invention. Although the FFT (fast fourier transform) module 1903, as well as the FEC (forward error correction) module 1904, could be mapped to the processing array of the present invention, the utility of an array implementation for these modules in channel decoding applications is generally not as great.

The present invention thus enhances flexibility for the convolution problem while retaining simple program and communication control. As well, an adaptive FIR can be realized using the present invention by downloading a simple program to each cell. Each program specifies periodic arithmetic processing for local tap updates, coefficient updates, and communication with nearest neighbors. During steady state processing, no high bandwidth communication with memory is required.

As required, the filter size, or quantity of filters to be mapped is scalable in the present invention beyond values expected for most channel decoding applications. Furthermore, the component architecture provides for insertion of non-filter function, control and external I/O without disturbing the array structure or complicating cell and routing optimization.

While the foregoing describes the preferred embodiment of the invention, it will be appreciated by those of skill in the art that various modifications and additions may be made. Such additions and modifications are intended to be covered by the following claims.

What is claimed:

1. Apparatus for implementing digital signal processing operations, comprising:
a two dimensional array of processing cells;
where each cell communicates with its nearest neighbors, and communication is programmed locally.

2. The apparatus of claim 1, where intercellular communication is restricted to said nearest neighbors.

3. The apparatus of claim 2, where said nearest neighbor communication is according to a programmable static scheme.

4. The apparatus of claim 3, where all tap computation, and all co-efficient and state storage is done locally in each cell.

5. The apparatus of claim 4, where each cell has four output ports.

6. The apparatus of claim 5, where each cell takes as inputs one of an output port from each of its nearest neighbors, an internally stored datum, or any combination of same.

7. The apparatus of claim 6, where each processing cell has memory to store mappings of various combinations of nearest neighbor output ports to its logical input ports.

8. The apparatus of claim 7, where said memory comprises registers.

9. The apparatus of any of claims 4-6, where each cell further comprises arithmetic control architecture.

10. The apparatus of claim 9, where said arithmetic control architecture comprises:
a local controller;
internal storage registers; and
a datapath element;

11. The apparatus of claim 10, where the datapath element can implement at least add, multiply, and shift operations.

12. The apparatus of claim 11, where said datapath element is provided RISC like opcodes by the local controller.

13. The apparatus of claim 9, where said arithmetic control architecture comprises:
a local VLIW controller;
internal storage registers; and
multiple datapath elements;

14. The apparatus of claim 13, where the datapath elements can each implement at least add, multiply, and shift operations.

15. The apparatus of claim 13, where the processing cell is realized as an ASIP.

16. The apparatus of claim 15, where said ASIP is generated by an architecture synthesis tool.

17. The apparatus of claim 9, further comprising one or more superimposed smaller two dimensional arrays, each such superimposed array communicating with the array one layer lower at specified convergence points with said one layer lower array.

18. The apparatus of claim 13, further comprising one or more superimposed smaller two dimensional arrays, each such superimposed array communicating with the array one layer lower at specified convergence points with said one layer lower array.

19. The apparatus of claim 17, further comprising a programmable border cell, which connects to available ports in all array hierarchies, and facilitates communications with external processes.

20. The apparatus of claim 19, further comprising a programmable border cell, which connects to available ports in all array hierarchies, and facilitates communications with external processes.

21. A method of efficiently computing digital signal processing operations, comprising:
mapping said computations to a two dimensional array of processing elements,
where each element communicates only with its nearest neighbors, and communication is programmed locally.

22. The method of claim 21, where each element's arithmetic processing is locally controlled, and all operations are relative to either input or output communication objects or local registers.

23. A multi standard channel decoder comprising the apparatus of claim 9, where said apparatus is configured to implement adaptive filtering.
